(19) United States
(12) Patent Application Publication
(10) Pub. No.: US 2013/0155565 A1
(43) Pub. Date: Jun. 20, 2013

(54) OVERCURRENT PROTECTION CIRCUIT

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/600,121

(22) Filed: Aug. 30, 2012

(30) Foreign Application Priority Data
Dec. 16, 2011 (CN) 201110423126.6

(51) Int. Cl. H02H 3/08

(52) U.S. Cl. 361/100; 361/93.1

(57) ABSTRACT

An overcurrent protection circuit includes a universal serial bus (USB) controller having an overcurrent detection pin, and a plurality of USB connectors each electronically connected to a USB device and the overcurrent detection pin. The USB controller communicates with the USB devices respectively via the USB connectors. When the overcurrent detection pin detects an overcurrent occurrence in one of the USB devices, the USB controller stops communicating with all of the USB devices.

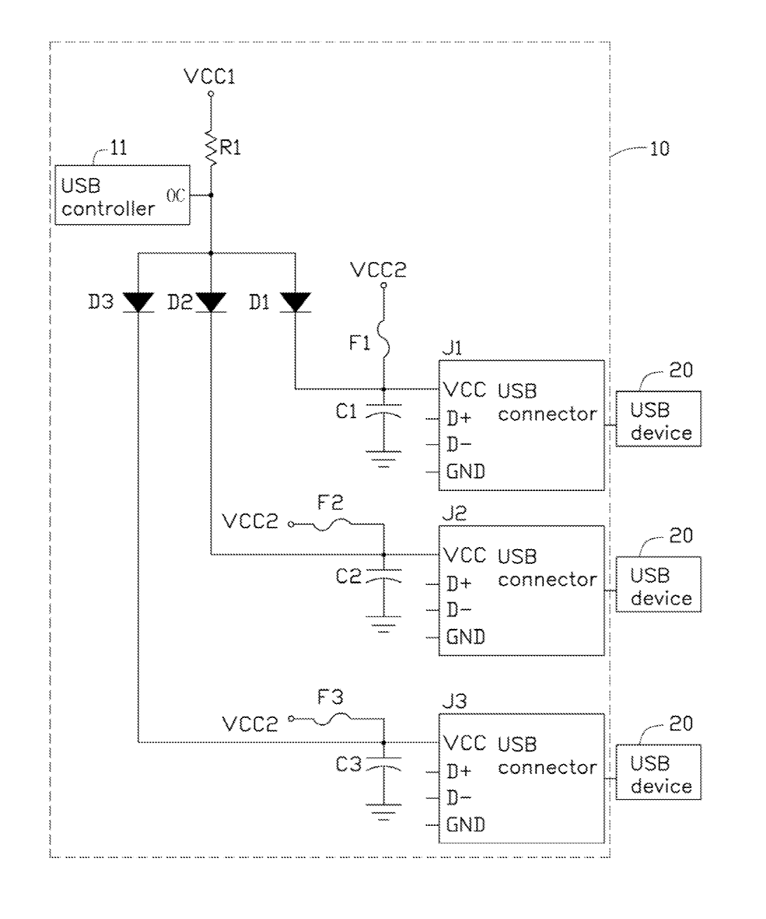

### BACKGROUND

1. Technical Field

The exemplary disclosure generally relates to overcurrent protection circuits, particularly to an overcurrent protection circuit for universal serial bus (USB) devices.

2. Description of Related Art

A typical USB controller used in a computer communicates with a plurality of USB devices via a respective plurality of USB connectors. The USB controller usually has a plurality of overcurrent detecting pins each configured for detecting whether an overcurrent occurs in a USB device. When the overcurrent occurs in a USB device, the USB controller stops communicating with the USB device to prevent the USB connector and the USB device from burning out due to the occurrence of the overcurrent.

However, because the USB controller is typically integrated within a south bridge chip, some overcurrent detecting pins of the USB controller may be used as general purpose input output (GPIO) pins of the south bridge chip occasionally, and cannot be used for overcurrent detection. Thus, at this time, some USB connectors of the computer cannot be protect from overcurrent by the USB controller.

Therefore, there is room for improvement within the art.

### BRIEF DESCRIPTION OF THE DRAWINGS

Many aspects of the embodiments can be better understood with reference to the drawing. In the drawing, the emphasis is placed upon clearly illustrating the principles of the disclosure.

The FIGURE is a schematic circuit diagram of an exemplary embodiment of an overcurrent protection circuit.

### DETAILED DESCRIPTION

The FIGURE is a schematic circuit diagram of an exemplary embodiment of an overcurrent protection circuit 10. The overcurrent protection circuit 10 includes a USB controller 11, a first power supply VCC1, a second power supply VCC2, a pull-up resistor R1, a plurality of USB connectors, a plurality of fuses, a plurality of diodes, and a plurality of filter capacitors. Each USB connector is electronically connected to a USB device 20. The USB controller 11 communicates with the USB devices 20 respectively via the USB connectors. In one embodiment, the USB overcurrent protection circuit 10 includes three USB connectors J1-J3, three fuses F1-F3, three diodes D1-D3, and three filter capacitors C1-C3.

The USB controller 11 has an overcurrent detection pin OC. The first power supply VCC is electronically connected to the overcurrent detection pin OC via the pull-up resistor R1. A node between the pull-up resistor R1 and the overcurrent detection pin OC is electronically connected to anodes of the diodes D1-D3. The cathodes of the diodes D1-D3 are electronically connected to power pins VCC respectively of the USB connectors J1-J3. A node between the diode D1 and the USB connector J1 is electronically connected to the second power supply VCC2 via the fuse F1, and is grounded via the filter capacitor C1. Similarly, a node between the diode D2 and the USB connector J2 is electronically connected to the second power supply VCC2 via the fuse F2, and is grounded via the filter capacitor C2. A node between the diode D3 and the USB connector J3 is electronically connected to the second power supply VCC2 via the fuse F3, and is grounded via the filter capacitor C3.

Each USB connector further includes a forward differential signal pin D+, and a reverse differential signal D−. The forward differential signal pins D+, and a reverse differential signal pins D− are electronically connected to the USB controller 11 to allow the USB connectors J1-J3 to communicate with the USB controller 11. Since the forward differential signal pins D+ and the reverse differential signal pins D− are connected to the USB controller 11 in a well-know way, the connection circuit between the USB controller 11 and the differential signal pins D+ and D− are not shown in the FIGURE.

The voltage of the first power supply VCC1 is lower than the voltage of the second power supply VCC2. In one embodiment, the voltage of the first power supply VCC1 is 3.3 volts, and the voltage of the second power supply VCC2 is 5 volts. When all of the USB devices 20 are working in a normal state, since the voltage of the first power supply VCC1 is lower than the voltage of the second power supply VCC2, the diodes D1-D3 are cut off, the voltage of the overcurrent detection pin OC is a high level voltage (e.g. logic 1). At this time, the USB controller 11 communicates with the USB devices 20 normally, and the USB devices 20 are powered by the second power supply VCC2 respectively via the USB connectors J1-J3. If an overcurrent occurs in any one of the USB device 20, that is, the current of one USB device 20 obtained from the second power supply VCC2 exceeds a threshold current, the USB controller 11 cuts off all communications with the USB devices 20. For example, when an overcurrent occurs in the USB device 20 connected to the USB connector J1, the fuse F1 connected between the USB connector J1 and the second power supply VCC is fused, to make the diode D1 to switch on. At this time, the voltage of the overcurrent detection pin OC is switched to a low level voltage (e.g. logic 0), the USB controller 10 stops communicating with all of the USB devices 20. Therefore, the plurality of USB connectors J1-J3 can share one overcurrent detection pin OC to obtain overcurrent protection, and the other overcurrent detection pins of the USB controller 11 can be always used as GPIO pins.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An overcurrent protection circuit, comprising:
a universal serial bus (USB) controller having an overcurrent detection pin;
a plurality of USB connectors each electronically connected to a USB device and the overcurrent detection pin;
wherein the USB controller communicates with the USB devices respectively via the USB connectors; when the overcurrent detection pin detects an overcurrent occurrence in one of the USB devices, the USB controller stops communicating with all of the USB devices.

2. The overcurrent protection circuit of claim 1, further comprising a first power supply, a second power supply, a pull-up resistor, a plurality of diodes, and a plurality of fuses, wherein the diodes and the fuses each equal in number to the number of the USB connectors, the first power supply is electronically connected to the overcurrent detection pin via the pull-up resistor, a node between the overcurrent detection pin and the pull-up resistor is electronically connected to an anode of each diode, a cathode of each diode is electronically connected to a power pin of a corresponding USB connector, a node between the cathode of each diode and the power pin of corresponding USB connector is electronically connected to the second power supply via a fuse.

3. The overcurrent protection circuit of claim 2, wherein the voltage of the first power supply is lower than the voltage of the second power supply.

4. The overcurrent protection circuit of claim 3, wherein each USB device is powered by the second power supply via a corresponding USB connector and a corresponding fuse, when an overcurrent occurs in one of the USB devices, the corresponding fuse connected between the second power supply and the USB connector is fused, to make a corresponding diode to switch on.

5. The overcurrent protection circuit of claim 2, further comprising a plurality of filter capacitors equal in number to the number of the USB connectors, a node between the cathode of each diode and the power pin of each USB connector is grounded via a filter capacitor.
